(19) United States
(12) Patent Application Publication
(10) Pub. No.: US 2026/0251994 A1
(43) Pub. Date: Aug. 27, 2026

(54) ELECTROPHOTOGRAPHIC CARRIER AND TWO-COMPONENT DEVELOPER

(71) Applicant: KANTO DENKA KOGYO CO.,LTD., Tokyo (JP)

(72) Inventors: Tomohiro IKEDA, Shibukawa-shi, Gunma (JP); Mitsunori ITO, Shibukawa-shi, Gunma (JP)

(21) Appl. No.: 18/862,330

(22) PCT Filed: May 11, 2023
(86) PCT No.: PCT/JP2023/017650

§ 371 Date: Nov. 1, 2024

(30) Foreign Application Priority Data
May 19, 2022 (JP) 2022-082537

(51) Int. Cl. G03G 9/113; G03G 9/107

(52) U.S. Cl. CPC G03G 9/1134; G03G 9/107

(57) ABSTRACT

Provided are a carrier for electrophotography and a two-component developer including the same. The resin-coated carrier for electrophotography includes a magnetic core particle and a resin layer coating the core particle. The coating layer includes: an acrylic resin A free of a styrenic component; an acrylic resin B containing a styrenic component; and a fluororesin; wherein the styrenic component is present less than 45.2 mass % in the total of the acrylic resins in the coating layer. The acrylic resin B preferably contains 30 to 90 mol % of a repeating unit derived from a styrenic monomer relative to the total repeating units of the acrylic resin B.

### TECHNICAL FIELD

This invention relates to a carrier for electrophotography and a two-component developer including the same. The carrier of the invention is for electrostatic latent image development.

### BACKGROUND ART

A two-component developer used in electrophotography includes a toner and a carrier. When a carrier is mixed and agitated with a toner in a developing unit, the carrier is triboelectrically charged to impart a desired charge to the toner and carries the charged toner to an electrostatic latent image on a photoreceptor to form a toner image on the photoreceptor. The carrier which remains on a magnet roller returns to the development unit and is repeatedly mixed and agitated with a fresh toner.

Therefore, it is necessary for the carrier to always achieve the functions required of a carrier for a toner under any environment during the period of its use, especially to provide stable charging characteristics. From this point of view, carriers composed of magnetic particles with a resin coating layer formed thereon are widely used.

In the electrophotographic technology, including copiers and printers, it is known that the resinous components, waxes, and external additives released from the spent toner after long-term printing are adhered to the carrier, and that such contamination of the carrier affects the carrier's electrical resistance (hereinafter, sometimes simply referred to as “resistance”) and the amount of charge of the developer. If the resistance of the carrier increases with the contamination due to the spent toner, the charge on the carrier surface may not be fully released immediately after development. This leads to unnecessary adhesion of the carrier, and specifically, the carrier may be transferred to the ends of the printed matter when printing halftones, for example. In addition, the spent toner problem can often lead to a reduction in the amount of the charge of the developer.

In addition, friction and collisions between carrier particles, friction between the carrier and a development sleeve, and contact between a doctor blade and the carrier cause the carrier's coating layer to peel off or abrade, resulting in excessive exposure of the carrier core material. This creates another problem of a decrease in the resistance of the carrier. Similarly, the increase in the amount of the charge of the carrier over time is also problematic in long-term printing.

With respect to the stabilization of the amount of the charge by adjusting the composition of the coating resin, patent literature 1 listed below discloses a carrier for electrophotography including a magnetic particle and a coating layer on the magnetic particle. The coating layer comprises a matrix resin containing a thermoplastic acrylic resin, fluorine-containing particles with an average particle size of 0.1 to 0.6 μm dispersed in the matrix resin, and positively chargeable particles with an average particle size of 0.1 to 0.6 μm dispersed in the matrix resin. The fluorine-containing particles contain a fluoropolymer having a tetrafluoroethylene unit content of at least 45 mol % relative to the total mass of the monomer units.

Patent literature 2 discloses a carrier for electrophotography composed of a magnetic particle and a resin layer formed on the surface thereof. The resin layer is formed of a styrene acrylic, acrylic, or methacrylic resin having a weight average molecular weight Mw of 30,000 to 150,000 and being substantially soluble in a predetermined solvent, and there is a specific relationship between the intrinsic resistivity (Ω·cm) of the carrier before dissolution in the predetermined solvent and that after the dissolution. The shape factor of the carrier after dissolution in the predetermined solvent (SF-1) is in the range of from 110 to 130.

Patent literature 3 discloses a carrier for electrophotography composed of a core material and a resin layer coating the core material. The resin coating layer contains a resin, carbon black, which is conductive particles, and magnetite, which is also conductive particles. The contents of the carbon black and the magnetite are 0.003 to 0.525 parts by mass and 0.030 to 5.250 parts by mass, respectively, per 100 parts by mass of the core material, and the weight ratio of the magnetite to the carbon black, magnetite/carbon black, is 5 to 100. It is purported in Patent literature 3 that the carrier has stable charging properties, high charge retention, and good adhesion between the core material and the resin coating layer even in continuous printing of many sheets.

### CITATION LIST

### Patent Literature

Patent literature 1: US 2008-0100846 A1
Patent literature 2: JP 2011-137867A
Patent literature 3: JP 2015-138229A

### SUMMARY OF INVENTION

In recent years, the use of low temperature fixing toners has been increasing for the purpose of saving energy in the fixing process, which is the most energy-intensive part of electrophotography. Compared with conventional toners, the low temperature fixing toners are prone to agglomeration and blocking, and in order to avoid this, a lot of external additives tend to be used. When using low temperature fixing toners, contamination of the carrier with spent toner and carrier agglomeration due to toner fusing on the surfaces of the carrier particles and bridging over the carrier particles are more likely to occur than with conventional toners. In addition, with increasing environmental concerns, longer-life carriers are being sought to reduce carrier waste. Thus, characteristics required of the carrier for electrophotography have been increasing over the years, including resistance to spent toner, resistance to agglomeration, and longer life.

From the above viewpoint, there is a need for a carrier for electrophotography that is excellent in abrasion resistance, balance between stable charging capability and stable electrical resistance in long-term printing, resistance to spent toner, and resistance to agglomeration.

As a result of the inventors' investigation, the carrier of patent literature 1 proved to be lacking in abrasion resistance, unsatisfactory in terms of achieving both stable charging capability and stable electrical resistance in long-term printing, and sometimes lacking in resistance to spent toner.

Patent literature 2 does not consider the composition for achieving a good balance between stable charging capability and stable electrical resistance in long-term printing, as well as resistance to agglomeration and abrasion.

Patent literature 3 leaves room for improvement in achieving all of the resistance to abrasion, resistance to spent toner, stable charging capability, and stability in electrical resistance.

An object of the invention is to solve the problems associated with the above-mentioned conventional techniques and to provide a carrier having excellent resistance to abrasion, stability in electrical resistance, and stable charging capability even in long-term printing, as well as resistance to spent toner and agglomeration, and also provide a developer including the carrier.

### Solution to Problem

The inventors have conducted intensive study to solve the above problems and have found that the above object is surprisingly accomplished by using a resin coating layer containing, as an acrylic resin, a combination of a styrene-free acrylic resin A and a styrene-containing acrylic resin B, and also a fluororesin, wherein the proportion of the styrenic component in the acrylic resin is controlled.

The invention provides [1] to [6] below.
[1] A resin-coated carrier for electrophotography, comprising a magnetic core particle and a resin layer coating the core particle,
   the coating layer comprising:
      an acrylic resin A free of a styrenic component;
      an acrylic resin B containing a styrenic component; and
      a fluororesin; wherein
   the styrenic component is present in a proportion of less than 45.2 mass % in the total of the acrylic resins in the coating layer.
[2] The carrier according to [1], wherein the acrylic resin B contains 30 to 90 mol % of a repeating unit derived from a styrenic monomer relative to the total repeating units of the acrylic resin B.
[3] The resin-coated carrier for electrophotography according to [1] or [2], wherein the coating layer has a content of the acrylic resin A of 55.0 to 81.0 parts by mass per 100 parts by mass of the total resins included in the coating layer.
[4] The resin-coated carrier for electrophotography according to any one of [1] to [3], wherein the coating layer has a content of the fluororesin of less than 20.0 parts by mass per 100 parts by mass of the total resins included in the coating layer.
[5] The resin-coated carrier for electrophotography according to any one of [1] to [4], wherein the fluororesin is polytetrafluoroethylene.
[6] A two-component developer including the resin-coated carrier for electrophotography according to any one of [1] to [5].

### Advantageous Effects of Invention

The carrier for electrophotography of the invention exhibits excellent resistance to abrasion, stability in electrical resistance, and stable charging capability even in long-term printing, as well as excellent resistance to spent toner and agglomeration. Thus, the invention can meet the demand for longer carrier life even under current conditions where carriers are easily contaminated by spent toner.

### BRIEF DESCRIPTION OF DRAWINGS

FIG. 1 is a schematic view illustrating the resistance measuring system used in Examples and Comparative Examples.

### DESCRIPTION OF EMBODIMENTS

The invention will be described in detail with reference to its embodiments, but the invention is not limited to these embodiments. It should be understood that various changes and modifications can be made within the scope of the invention without departing from its spirit. The description may be omitted to avoid redundancy, but this does not limit the gist of the invention.

The invention relates to a resin-coated carrier including a magnetic core particle and a resin layer coating the surface of the core particle. The coating layer contains at least an acrylic resin free of a styrenic component (herein also referred to as “styrene-free acrylic resin A” or “acrylic resin A”), an acrylic resin containing a styrenic component (herein also referred to as “styrene-containing acrylic resin B” or “acrylic resin B”), and a fluororesin. The styrenic component is present in a proportion of less than 45.2 mass % in the total of the acrylic resins in the coating layer. The inventors have found out that the carrier of the invention is excellent in abrasion resistance and also in stability in electrical resistance and charging capability even in long-term printing under conditions where the carrier is susceptible to contamination due to spent toner, as well as resistance to contamination due to spent toner and resistance to agglomeration. Although the reasons for this achievement are not clearly elucidated, the inventors believe as follows: by coating magnetic particles with a resin solution containing the styrene-free acrylic resin A and the styrene-containing acrylic resin B, the styrene-free acrylic resin A and the styrene-containing acrylic resin B coexist while forming the interfaces with each other, whereby the fluororesin is easily fixed in the resin coating layer; and as a result, the fluororesin is allowed to provide improved resistance to contamination due to spent toner and agglomeration, leading to the improvement in stability in charging capability and electrical resistance. Furthermore, such a resin composition is considered to be particularly suitable for improving abrasion resistance.

### Core Particle

The core particles used in the invention are magnetic particles. The core particles will also be referred to as a core material. The magnetic core material is not particularly limited and can be selected, depending on the intended use, from the group consisting of iron powder, magnetite, Mn ferrite, Mn—Zn ferrite, Mn—Mg ferrite, Mn—Mg—Sr ferrite, and Mg ferrite, and these ferrites may contain an alkali metal, an alkaline earth metal, or a light metal. If necessary, the magnetic particles may be oxidation treated. Inter alia, a ferrite core material is preferred, and Mn- or Mg-containing ferrite core material is more preferred.

The core particles preferably have an average particle size of, but not limited to, 20 to 90 μm, more preferably 30 to 80 μm. Also, the carrier (resin-coated core particles) preferably has an average particle size of 20 to 90 μm, more preferably 30 to 80 μm.

The average particle sizes of the core particles and the carrier can be determined using a laser diffraction particle size analyzer (HELOS, from Sympatec GmbH) combined with a dry dispersion unit (RODOS, from Sympatec GmbH). As used herein, the term “average particle size” with respect to the core particles and the carrier refers to the volume-based average particle size.

The saturation magnetization of the core particles is preferably, but not limited to, 20 to 110 Am²/kg, more preferably 30 to 100 Am²/kg, even more preferably 35 to 90 Am²/kg. The saturation magnetization can be determined by using a vibrating sample magnetometer BHV-35H from Riken Denshi Co., Ltd., wherein a sample is placed into a measuring capsule (0.0565 cc), and a magnetic field of 1.1 MA/m is applied. The saturation magnetization of the carrier (resin-coated core particles) is also preferably, but not limited to, 20 to 110 Am²/kg, more preferably 30 to 100 Am²/kg, even more preferably 35 to 90 Am²/kg.

### Resin Coating Layer

The resin layer coating the surface of the core particle is also referred to as “resin coating layer” or “coating layer”.

In the present invention, the resin coating layer contains the styrene-free acrylic resin A, styrene-containing acrylic resin B, and fluororesin. As used hereinafter, the term “(meth)acrylic” refer to acrylic and/or methacrylic (i.e., “acrylic”, “methacrylic”, or both of “acrylic” and “methacrylic”).

The styrene-free acrylic resin A will be described below.

Examples of the styrene-free acrylic resin A include acrylic polymers and their derivatives, and mixtures of an acrylic polymer or its derivative and at least one of acrylic monomers and acrylic oligomers. The acrylic resin A is preferably free of fluorine.

Examples of the acrylic monomers include (meth)acrylic acid, (meth)acrylic esters, amide-containing acrylic monomers, and (meth)acrylonitrile. Examples of the (meth)acrylic esters include alkyl (meth)acrylates, such as methyl methacrylate, ethyl methacrylate, ethyl acrylate, butyl acrylate, and 2-ethylhexyl acrylate; hydroxy-containing (meth)acrylates, such as 2-hydroxyethyl methacrylate; and quaternary ammonium salt-containing (meth)acrylates, such as dimethylaminoethyl methacrylate methyl chloride quaternary salt and trimethylaminoethyl acrylate benzyl chloride quaternary salt. Examples of the amide-containing acrylic monomers include (meth)acrylamide and N-hydroxyethyl (meth)acrylamide.

Examples of the acrylic oligomers include oligomers of at least one acrylic monomer. The term “oligomer” also encompasses dimers and trimers. The oligomers are usually composed of about 2 to 20 monomer units.

The acrylic polymers include those obtained by polymerization of the above recited acrylic monomers and/or oligomers. Examples thereof include homopolymers composed of a single kind of repeating unit derived from one of the acrylic monomers; copolymers composed of two or more kinds of repeating units derived from two or more of the acrylic monomers; and copolymers composed mainly of one or more kinds of repeating unit derived from the acrylic monomer(s) and additionally of a repeating unit derived from a monomer other than the acrylic monomers or styrenic monomers. When the copolymers are composed mainly of one or more kinds of repeating unit derived from the acrylic monomer(s), the percentage of the one or more kinds of repeating unit derived from the acrylic monomer(s) in the total repeating units is preferably at least 80 mass %, more preferably 90 mass % or more, even more preferably 92 mass % or more, still even more preferably 95 mass % or more, yet even more preferably 98 mass % or more.

Examples of the derivatives of the acrylic polymers include those derived from the acrylic polymers through various modifications, such as terminal modification and substituent introduction. Examples of the modifications include modification with glycidyl ethers, introduction of oxirane, and modification with hydroxy groups, carboxy groups or sulfonic acid.

The acrylic polymers and their derivatives, which constitute the acrylic resin A, preferably have a weight average molecular weight of 5,000 to 1,000,000. When the weight average molecular weight is at least 5,000, the resin coating layer formed on the core particle is protected against excessive promotion of abrasion. When the weight average molecular weight is not more than 1,000,000, reduction in the charge due to transfer of external additives from the toner to the carrier surface is less likely to occur. From these points of view, the weight average molecular weight of the acrylic polymers or their derivatives constituting the acrylic resin A is more preferably 7,000 to 500,000, even more preferably 10,000 to 100,000.

The weight average molecular weight can be determined, in terms of standard polystyrene, by gel permeation chromatography (GPC). GPC can be performed using, for example, a GPC system (HLC-8320 from Tosoh Corp.) having two TSKgel GMHXL columns and one TSKgel Multipore HXL-M column (both from Tosoh Corp.) with tetrahydrofuran as an elution solvent and polystyrene standards for calibration. The column temperature may be 40° C., and the flow rate can be 1 mL/min.

When the acrylic resin A is a mixture of an acrylic polymer or its derivative and an acrylic monomer and/or oligomer, the preferred content of the acrylic monomer and/or oligomer in the acrylic resin A is such that the weight average molecular weight of the acrylic resin A, i.e., the mixture of the acrylic monomer and/or oligomer and the acrylic polymer or its derivative, is within the above preferred range.

In view of achieving resistance to spent toner, desirable stability in charging capability and electrical resistance, resistance to abrasion, and resistance to agglomeration, the acrylic resin A preferably has a repeating unit derived from an alkyl (meth)acrylate, and especially, the acrylic resin A includes the repeating unit derived from an alkyl (meth)acrylate preferably in an amount of 50 mass % or more, in view of forming a favorable interface with the acrylic resin B. The amount of the repeating unit derived from an alkyl (meth)acrylate is more preferably 70 mass % or more, even more preferably 80 mass % or more, still more preferably 90 mass % or more, yet more preferably 92 mass % or more, still even more preferably 95 mass % or more, still yet more preferably 98 mass % or more. The alkyl (meth)acrylate is preferably an alkyl methacrylate, more preferably methyl methacrylate or ethyl methacrylate, most preferably methyl methacrylate. Polymethyl methacrylate (PMMA) is an example of the acrylic resin A that is 100% composed of a repeating unit derived from an alkyl (meta)acrylate.

As used herein, the term “free of a styrenic component” or, in shorter words, “styrene-free” means that the polymer does not contain a repeating unit derived from a styrenic monomer. The term “styrenic monomer” refers to a compound having a benzene ring with a vinyl group bonded thereto, and examples thereof will be recited below.

With a view to advantageously obtaining resistance to spent toner, stability in charging capability and electrical resistance, resistance to abrasion, and resistance to agglomeration, the coating layer preferably has a content of the acrylic resin A of 55 to 81 parts by mass, more preferably 60 to 81 parts by mass, per 100 parts by mass of the total resins included in the coating layer, and the content of the acrylic resin A may be 60 to 75 parts by mass, per 100 parts by mass of the total resins included in the coating layer.

Next, the styrene-containing acrylic resin B will be described.

Examples of the styrene-containing acrylic resin B include copolymers composed of a repeating unit derived from an acrylic monomer and a repeating unit derived from a styrenic monomer, and their derivatives, and specifically include copolymers of an acrylic monomer and/or an acrylic oligomer and a styrenic monomer and/or a styrenic oligomer. The acrylic resin B is preferably free of fluorine. The copolymers containing a repeating unit derived from styrenic monomer and/or styrene oligomer may be a random, block, alternate, or graft copolymer.

Examples of the acrylic monomer are the same as listed above for the acrylic resin A.

The styrenic monomer includes styrene and substituted styrenes. Examples of the substituted styrenes include styrene having a substituted ring (also referred to as “ring-substituted styrene”) and styrene having α-substituted alkyl (also referred to as “α-substituted styrene”). The ring-substituted styrenes include those obtained by replacing one or more hydrogen atoms on the benzene ring with, e.g., a C1-C5 alkyl, C1-C5 alkoxy, or sulfonic group. Specific examples of the ring-substituted styrenes include o- or p-methylstyrene, p-methoxystyrene, p-t-butylstyrene, p-n-butylstyrene, p-t-butylstyrene, and p-chlorostyrene. Specific example of the a-substituted styrenes include a-methylstyrene. The styrenic oligomer includes oligomers obtained by polymerizing at least one styrenic monomer. The term “oligomer” usually refers to those composed of about 2 to 20 monomer units.

Preferred styrenic monomers include styrene and the ring- or a-substituted styrenes having a substituent with less than 4 carbon atoms. At least one styrenic monomer selected from o-methylstyrene, p-methylstyrene, and α-methylstyrene is more preferred. Styrene is the most preferred.

The derivatives of the copolymers composed of a repeating unit derived from acrylic monomer and a repeating unit derived from styrenic monomer include those obtained by modifying the copolymers by, for example, terminal modification or introduction of substituents. Examples of the modification include glycidyl ether modification, oxirane introduction, hydroxyl group modification, carboxyl group modification, and sulfonic acid modification.

The acrylic resin B preferably has a weight average molecular weight of 5,000 to 1,000,000. When the weight average molecular weight is at least 5,000, the resin coating layer formed on the core particle is protected against excessive promotion of abrasion. When the weight average molecular weight is not more than 1,000,000, reduction in the charge due to transfer of external additives from the toner to the carrier surface is less likely to occur. From these points of view, the weight average molecular weight of the acrylic polymers or their derivatives constituting the acrylic resin B is more preferably 7,000 to 500,000, even more preferably 10,000 to 100,000. The weight average molecular weight of the acrylic resin B can be determined in the same manner as for the acrylic resin A.

The ratio between the amount of the acrylic resin A and that of the acrylic resin B and the proportion of the styrenic component in the acrylic resin B are such that the styrenic component is present in a proportion of less than 45.2 mass % in the total acrylic resins. The proportion of the styrenic component in the total acrylic resins is the proportion by mass of the repeating unit derived from the styrenic monomer in the total of the acrylic resins A and B. As long as the proportion of the styrenic monomer in the acrylic resins is less than 45.2 mass %, the spent toner resistance, stable charging capability, and abrasion resistance are achieved. From this viewpoint, the proportion of the styrenic component in the total of the acrylic resins is preferably 35 mass % or less, more preferably 30.3 mass % or less.

With a view to advantageously obtain resistance to spent toner, stability in charging capability and electrical resistance, resistance to abrasion, and resistance to agglomeration, the proportion of the styrenic component in the total acrylic resins is particularly preferably 4.3 mass % or higher to obtain the full effects of the interface. A proportion of 10 mass % or higher is also preferred.

The proportion of the styrenic component, i.e., the repeating unit derived from the styrenic monomer in the total repeating units of the acrylic resin B is preferably 30 to 90 mol %. The proportion of 30 mol % or more is preferred for obtaining the full effects of the interface. The proportion of 90 mol % or less is preferred for advantageously obtaining abrasion resistance. From these points of view, the proportion of the styrenic component in the total repeating units of the acrylic resin B is more preferably 60 to 90 mol %, even more preferably 80 to 90 mol %.

From the same points of view, the proportion of the repeating unit derived from the acrylic monomer in the total units constituting the acrylic resin B is preferably 10 to 70 mol %, more preferably 10 to 40 mol %, even more preferably 10 to 20 mol %.

The acrylic monomer used to produce the acrylic resin B is preferably an alkyl (meth)acrylate, more preferably alkyl methacrylate, even more preferably methyl or ethyl methacrylate, most preferably methyl methacrylate. The acrylic monomer used in the acrylic resin A and that in the acrylic resin B may be the same or different.

With a view to advantageously obtain resistance to spent toner, stability in charging capability and electrical resistance, resistance to abrasion, and resistance to agglomeration, the total amount of the acrylic resins A and B in all the resins included in the coating layer is preferably at least 70 mass %, more preferably 80 mass % or more, even more preferably 82.5 mass % or more.

With the intension of adjusting the proportion of the styrenic component so as to be less than 45.2 mass % in the total acrylic resins of the coating layer to more advantageously obtain resistance to spent toner, stability in charging capability and electrical resistance, resistance to abrasion, and resistance to agglomeration, the amount of the acrylic resin B is preferably 1.5 to 50 parts by mass, more preferably 3 to 45 parts by mass, per 100 parts by mass of the acrylic resin A.

Next, the fluororesin will be described.

The fluororesin is a resin having a repeating unit derived from a fluoroalkylene, preferably a perfluoroalkylene, even more preferably tetrafluoroethylene. Examples of suitable fluororesins include a homopolymer of tetrafluoroethylene and a copolymer of tetrafluoroethylene and another fluorine-containing monomer. The other fluorine-containing monomer is preferably a fluorine-containing monomer copolymerizable with tetrafluoroethylene. Examples of such a copolymerizable fluorine-containing monomer include fluoroalkylenes and fluoroalkyl vinyl ethers, and specifically preferably perfluoroalkylenes, such as perfluoropropylene, and perfluoroalkyl vinyl ethers, such as perfluoropropyl vinyl ether and perfluoroethyl vinyl ether.

Accordingly, examples of preferred fluororesins include polytetrafluoroethylene, tetrafluoroethylene-perfluoroalkyl vinyl ether copolymers, and tetrafluoroethylene-hexafluoropropylene copolymers.

The fluororesin preferably contains a repeating unit derived from tetrafluoroethylene in a high proportion, and particularly, the proportion of a repeating unit derived from tetrafluoroethylene is preferably 50 mol % or more, more preferably 90 mol % or more, in the total mass of the monomer units constituting the fluororesin. Inter alia, polytetrafluoroethylene is the most preferred.

The fluororesin is preferably present in the form of fine particles in the resin coating layer. Such particulate fluororesin preferably has an average primary particle size of 0.01 to 1 μm, more preferably 0.1 to 0.7 μm. The primary particle size of the fluororesin herein is an average of the Feret's diameters of the particles observed by SEM. Specifically, it is obtained as an average of the Feret's diameters of at least 50 randomly selected particles measured preferably at a magnification of about 10,000× to 20,000×.

The fluororesin preferably has a BET specific surface area of 2 to 15 m²/g, more preferably 2 to 11 m²/g. The BET specific surface area of the fluororesin can be measured using nitrogen gas.

The fluororesin preferably has a melting point of 250° to 410° C. in view of ease of uniformly covering the surface of the core particles and reduction of the carrier surface energy which is effective in preventing contamination of the carrier with an external toner additive. To ensure these effects, the melting point of the fluororesin is more preferably 300° to 360° C. The melting point of the fluororesin can be measured with a differential scanning calorimeter (DSC). Preferably, the weight average molecular weight of the fluororesin is adjusted so that its melting point may fall within the above range.

The fluororesin is preferably used in an amount of less than 20 parts by mass, more preferably 17.5 parts by mass or less, per 100 parts by mass of all the resins included in the coating layer in view of ease of uniformly covering the surface of the core particles with the resins for the coating layer. The amount of the fluororesin is preferably at least 2.5 parts by mass, more preferably 5 parts by mass or more, per 100 parts by mass of all the resins included in the coating layer, in terms of advantageously obtaining resistance to spent toner, stability in charging capability and electrical resistance, resistance to abrasion, and resistance to agglomeration.

The coating layer may contain additional resins other than those described above, such as silicone resins and acryl-silicone resins.

### Other Components

It is preferable that the resin coating layer further contain conductive particles in view of providing stable charging capability and controlling the electrical resistance for proper imaging. From this point of view, carbon black is particularly preferred as conductive particles.

Useful carbon blacks include ketchen black, furnace black, acetylene black, and channel black. Commercially available carbon black products include VULCAN XC72R, REGAL 330R, BLACK PEARLS 2000, and MONARCH 120, all from Cabot Corp., and MA100 and MA7, both from Mitsubishi Chemical Corp.

The carbon black preferably has a BET specific surface area of 25 to 1500 m²/g. The carbon black preferably has an average particle size of 100 nm or less. The average particle size of the carbon black is an average of the Feret's diameters of, for example, at least 50 particles measured on images obtained by SEM. The average particle size of the carbon black is preferably 1 nm or greater.

The carbon black content in the resin coating layer is preferably 1 to 15 parts by mass per 100 parts by mass of all the resins of the coating layer in the resin-coated carrier of the present invention.

The resin coating layer may further contain an inorganic filler. The inorganic filler advantageously allows adjustment of the amount of charge and electrical resistance and also suppression of changes in the properties of the carrier under high temperature/high humidity conditions or low temperature/low humidity conditions. Examples of useful inorganic fillers include hydrotalcite, silica, titania, magnesia, alumina, zinc oxide, and barium sulfate.

In a case where hydrotalcite is used as an inorganic filler, its volume-based average particle size D50 (the diameter at 50% of the cumulative volume) is preferably 0.01 to 1.0 μm, more preferably 0.05 to 0.8 μm. Hydrotalcite is preferably used in an amount of 0.1 to 100 parts by mass, more preferably 1 to 50 parts by mass, per 100 parts by mass of all the resins included in the coating layer. The volume-based D50 can be determined by the laser diffraction method.

In a case where silica is used as an inorganic filler, its specific surface area is preferably 10 to 400 m²/g, more preferably 30 to 350 m²/g. Silica is preferably used in an amount of 0.1 to 100 parts by mass, more preferably 1 to 50 parts by mass, per 100 parts by mass of all the resins included in the coating layer.

In a case where titania is used as an inorganic filler, its BET specific surface area is preferably 20 to 150 m²/g, more preferably 30 to 130 m²/g/. Titania is preferably used in an amount of 0.1 to 100 parts by mass, more preferably 1 to 50 parts by mass, per 100 parts by mass of all the resins included in the coating layer.

In a case where using magnesia is used as an inorganic filler, the specific surface area is preferably 0.5 to 200 m²/g, more preferably 0.6 to 150 m²/g. Magnesia is preferably used in an amount of 0.1 to 100 parts by mass, more preferably 1 to 50 parts by mass, per 100 parts by mass of all the resins included in the coating layer.

The inorganic fillers can be used in a total amount of 0.1 to 100 parts by mass, preferably 1 to 50 parts by mass, per 100 parts by mass of all the resins included in the coating layer.

The method of forming the resin coating layer on the core particles is not particularly limited and preferably includes dipping or spray coating using a fluidized bed. The coating process may be followed by a heating treatment, or the coating may be performed simultaneously with the heat treatment in a coating process unit. When the coating process is followed by the heat treatment, a heating furnace may be used, such as a hot air circulation oven, a fluidized electric furnace, or a microwave heating furnace.

While the amount of the resin coating varies depending on the types of the resins and the required charging characteristics and electrical resistance characteristics of the carrier, the total amount of the resins included in the resin coating layer is preferably in the range of from 0.1 to 10 parts by mass per 100 parts by mass of the core particles. With at least 0.1 parts by mass of the resins, the core particles are easily uniformly coated. When the total amount of the resins is not more than 10 parts by mass, problems such as increased occurrence of association of the particles can be prevented. The above amount of the resins is in terms of the solids content.

The invention also provides a method for producing a resin-coated carrier for electrophotography, the method including the step of contacting core particles with a coating resin composition. The coating resin composition contains at least three kinds of resins—the styrene-free acrylic resin A, the styrene-containing acrylic resin B, and the fluororesin—and a liquid medium. The proportion of the styrenic component in the coating layer is less than 45.2 mass % based on the total acrylic resins in the coating layer. This method is suitable to produce the resin-coated carrier for electrophotography of the invention.

In this method, the step of contacting core particles with the coating resin composition can be carried out by the method described above as a means for forming the resin coating layer on the core particles. The components of the coating resin composition and preferences thereof are selected as appropriate from those described for the resin coating layer. The coating resin composition preferably contains 3 to 60 mass % of the resins in terms of the solids content. The coating resin composition can be prepared by using a liquid medium, such as toluene, xylene, methyl ethyl ketone, methyl isobutyl ketone, ethyl acetate, butyl acetate, tetrahydrofuran, diethyl ether, acetone, and N-methylpyrrolidone. The coating resin composition can be used in the form of a resin solution containing such a solvent as will be described in Examples. The method for producing a resin-coated carrier for electrophotography may include the step of forming a resin layer coating the surface of the core particles by bringing the coating resin composition into contact with the core particles.

The carrier of the invention preferably has a resistance value of 1E+5 to 1E+13Ω, more preferably 1E+6 to 1E+12Ω, at an applied voltage of 500 V. When the resistance value of the carrier falls within the above range, the carrier exhibits excellent stability in electrical resistance as well as stable charging capability, and good resistance to spent toner, agglomeration, and abrasion, thereby enabling stable printing.

The invention also relates to a two-component developer for electrophotography containing the above-described carrier for electrophotography and a toner. Any type of toner may be used, including pulverized toner and polymerized toner. A developer is configured with either a positively chargeable toner or a negatively chargeable toner depending on the image forming apparatus. The positively chargeable toner to be combined with the carrier of the invention is preferably prepared by using a nigrosine dye or a quaternary ammonium salt as a charge control agent. The negatively chargeable toner to be combined with the carrier of the invention is preferably prepared by using a monoazo dye.

The toner suitable for use in the invention is preferably formed of a binder resin having a colorant, a charge control agent, and so forth dispersed therein. Any binder resins may be used, including polystyrene resins, styrene-acrylic resins, polyester resins, epoxy resins, and polyurethane resins. The colorant and charge control agent can be selected from known materials as appropriate. If needed, a wax and an external additive may be used. The external additive includes inorganic particles, such as silica, titania, alumina, titania, zirconia, and zinc oxide, and melamine-based or fluorinated organic particles. As used herein, the term “two-component” is intended to mean, for the sake of convenience, that the developer is primarily composed of the two components, carrier and toner, and does not exclude the presence of other components.

### EXAMPLES

The invention will now be illustrated in greater detail by way of Examples and Comparative Examples, but it should be understood that the invention is not deemed to be limited thereto. Materials used in the preparation of coating resin solutions are shown below. Unless otherwise indicated, all the parts and percentages are given by mass. The amounts of the materials shown in Tables 1 and 2 are in units of parts by mass.

### Acrylic Resin A

A-1: polymethyl methacrylate (weight average molecular weight (Mw): 30,000; styrenic component: 0%)
A-2: polymethyl methacrylate derivative (containing at least 98% of a repeating unit derived from methyl methacrylate and not more than 2% of a repeating unit derived from a quaternary ammonium salt-containing (meth)acrylate; Mw: 30,000; styrenic component: 0%)
A-3: polycyclohexyl methacrylate (Mw: 50,000; styrenic component: 0%)

### Acrylic Resin B

B-1: methyl methacrylate/styrene copolymer; molar ratio 70/30 (Mw: 30,000, random copolymer)
B-2: methyl methacrylate/styrene copolymer; molar ratio 40/60 (Mw: 30,000, random copolymer)
B-3: methyl methacrylate/styrene copolymer; molar ratio 10/90 (Mw: 30,000, random copolymer)
B′-1: polystyrene resin (Mw: 5,500)
B′-2: melamine resin (U-VAN 20SE60, from Mitsui Chemicals, Inc.)

### Fluororesin

C-1: PTFE (polytetrafluoroethylene; average primary particle size: 0.3 μm; “Fluon PTFE Lub L170JE” from AGC Inc.; melting point: 332° C.; BET specific surface area as measured with N₂: 8.2 m²/g)

### Additive

D-1: carbon black (average particle size: 30 nm; BET specific surface area: 254 m²/g)
D-2: hydrotalcite (volume-based D50: 0.1 μm)

### Others

E-1: silica (BET specific surface area: 50 m²/g)
E-2: silica (BET specific surface area: 300 m²/g)
E-3: titania (BET specific surface area: 50 m²/g)
E-4: magnesia (BET specific surface area: 130 m²/g)

### Example 1

In 500 parts of toluene as a solvent were mixed and dissolved 81 parts of acrylic resin A-1 and 4 parts of acrylic resin B-3 at 70° C. To the resulting solution was added 15 parts of fluororesin C-1, followed by mixing. In addition, 6 parts of carbon black (D-1) as an additive was added, followed by mixing to prepare a coating resin solution.

The resulting resin solution was applied to MnMg ferrite particles as a core material (average particle size: 40 μm; saturation magnetization: 63 Am²/kg) in a fluidized bed spray coating machine while the amount of the resin solids was adjusted so as to be 1.5 parts per 100 parts of the core material. After drying the solvent, the coated particles were heated at 120° C. for 2 hours in a hot air circulation oven and then allowed to pass through a 75 μm mesh screen to remove coarse particles, to thereby give a carrier of the invention with an average particle size of 40 μm (see Table 1).

### Examples 2 to 12 and Comparative Examples 1 to 7, 10, 11, and 17

A carrier was obtained in the same manner as in Example 1, except for changing the acrylic resins A and B and the fluororesin C as shown in Table 1 or 2.

### Example 13 to 15 and Comparative Examples 8, 9, and 16

A carrier was obtained in the same manner as in Example 1, except for changing the acrylic resins A and B, the fluororesin C, and the additive as shown in Tables 1 or 2.

### Examples 16 to 19

A carrier was obtained in the same manner as in Example 4, except for adding one of the additives E-1 to E-4 in addition to the carbon black as described in Table 1.

### Comparative Examples 12 to 15

A carrier was obtained in the same manner as in Example 1, except for changing the amount or type of the acrylic resin A as indicated in Table 2 and also using a melamine resin or polystyrene resin in place of the acrylic resin B in the amount shown in Table 2.

### Preparation of Developer

In a V-type mixer, 93 parts of the carrier produced in any of Examples and Comparative Examples and 7 parts of a negatively chargeable toner (cyan toner, for LaserJet Enterprise Color MFP M776zs, from HP Co.) were mixed by stirring for 30 minutes in an environment of 22° C. and 55% RH to prepare a developer.

### Evaluation

The developer was subjected to accelerated deterioration. Specifically, the developer was stirred in a modified copying machine as a deteriorator for 1 hour; the toner was removed from the deteriorated developer using a q/m-meter from Epping GmbH; the equal amount of fresh toner was added to make a developer, which was then stirred in the deteriorator; and this deterioration cycle was repeated a total of four times. The resulting deteriorated developer was evaluated according to the methods described below and ranked A, B, or C. Developers given B in two or fewer evaluation items with A in the remaining items were considered acceptable, while those given B in three or more evaluation items or C in one or more evaluation items were not considered acceptable.

### Stability in Charging Capability

The amount of charge of the developer was compared between the first and forth deterioration cycles. The amount of tribocharge Q was measured using a q/m-meter from Epping GmbH, and the AT value was calculated using the following formula:

$$AT = Q / m \times T / D$$

where Q is the amount of tribocharge; m is the mass of the developer; T is the toner concentration; and D is the weight of the developer.

The change of the AT value was calculated using the following formula:

$$Change ( \% ) = ( {AT}_{1} - {AT}_{4} ) / {AT}_{1} \times 100$$

where AT₁ and AT₄ are the AT values after the first and fourth deterioration cycles, respectively.

The absolute value of the change was rated on the following scale:
A: The absolute value of the change is less than 10%.
B: The absolute value of the change is 10% or more and less than 20%.
C: The absolute value of the change is 20% or more.

### Retention of Electrical Resistance

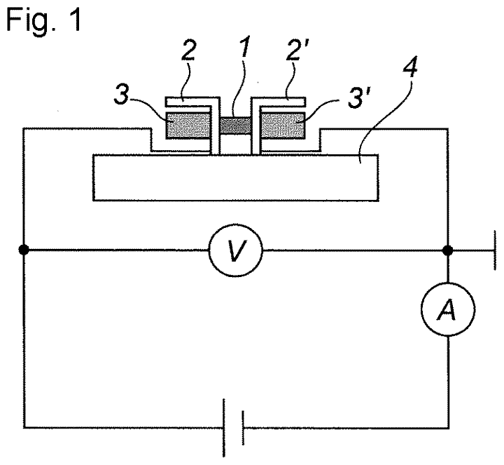

The electrical resistance of the carrier before the deterioration cycles and that after the fourth deterioration cycle and the toner removal were measured, using a measuring instrument in which an N pole and an S pole were placed to face each other at a distance of 6 mm (surface magnetic flux density of the magnetic poles: 1500 G, facing magnetic pole area: 10 mm×30 mm). The schematic circuit diagram of the measuring instrument is shown in FIG. 1. As shown in FIG. 1, nonmagnetic parallel plate electrodes 2 and 2′ (electrode area: 10 mm×40 mm, distance between the electrodes: 2 mm) were arranged between the magnetic poles 3 and 3′, and 200 mg of a sample carrier 1 was disposed between the electrodes 2 and 2′ so that the carrier 1 was held between the electrodes 2 and 2′ by the magnetic force. A 500 V DC voltage was applied to the electrodes 2 and 2′, and the electrical resistance value (Ω) was measured using an insulation resistance meter (TR-8601, from Takeda Riken Kogyo) and converted to a logarithmic value. From the logarithmic values converted from the electrical resistance values, the absolute value of the change (R₀-R₄; where R₀ and R₄ are the logarithmic values converted from the electrical resistance value of the carrier before deterioration and that after the fourth deterioration cycle and the toner removal, respectively) was calculated, and the result was rated on the following scale. In FIG. 1, reference numerals 1 and 4 indicate the carrier and a support, respectively.
A: The absolute value of the change is less than 0.5.
B: The absolute value of the change is 0.5 or more and less than 1.
C: The absolute value of the change is 1 or more.

### Resistance to Spent Toner

The Si intensity of the carrier before deterioration (Si₀: in kcps) and that after the fourth deterioration cycle and after the toner removal, (Si₄: in kcps) were determined using an X-ray fluorescence analyzer (ZSX Primus IV, from Rigaku Corp.). The change of the Si intensity (Si₄-Si₀) was calculated and rated on the following scale:
A: The change is less than 3 kcps.
B: The change is 3 kcps or more and less than 4.5 kcps.
C: The change is 4.5 kcps or more.

### Resistance to Agglomeration

The volume-based D50 of the carrier before deterioration (D50₀) and that after the fourth deterioration cycle and the toner removal (D50₄) were determined, using a laser diffraction particle size analyzer (HELOS, from Sympatec) combined with a dry dispersion unit (RODOS, from Sympatec). From the resulting D50s, the change in D50 (D50₀-D50₄) (μm) was calculated and rated on the following scale.
A: The change is less than 0.5 μm.
B: The change is 0.5 μm or more and less than 1 μm.
C: The change is 1 μm or more.

### Resistance to Abrasion

The exposed area percentage of core particles was quantified through SEM image analysis. Images of 100 to 150 carrier particles were analyzed by image analysis software to obtain the proportion of the exposed area of the core particles to the area of the carrier particles, i.e., the exposed area percentage. The SEM used was S-3400N from Hitachi High-Tech Corp. The change in the exposed area percentage (S₄-S₀) was calculated, where S₀ is the exposed area percentage of the carrier before deterioration and S₄ is that after the fourth deterioration cycle and after the toner removal. The result was rated on the following scale.
A: The change is less than 3.5%.
B: The change is 3.5% or more and less than 7%.
C: The change is 7% or more.

TABLE 1

| Example | Acrylic Resin A | | Acrylic Resin B | | | Fluororesin | Additive | | | |
|---|---|---|---|---|---|---|---|---|---|---|
| No | A-1 | A-2 | B-1 | B-2 | B-3 | C-1 | D-1 | D-2 | Others | |
| 1 | 81.0 | | | | 4.0 | 15.0 | 6.0 | | | |
| 2 | 65.0 | | 20.0 | | | 15.0 | 6.0 | | | |
| 3 | 65.0 | | | 20.0 | | 15.0 | 6.0 | | | |
| 4 | 65.0 | | | | 20.0 | 15.0 | 6.0 | | | |
| 5 | 55.0 | 10.0 | | | 20.0 | 15.0 | 6.0 | | | |
| 6 | 65.0 | | | | 20.0 | 15.0 | 6.0 | | | |
| 7 | 56.5 | | | | 28.5 | 15.0 | 6.0 | | | |
| 8 | 74.6 | | | | 22.9 | 2.5 | 6.0 | | | |
| 9 | 72.6 | | | | 22.4 | 5.0 | 6.0 | | | |
| 10 | 68.8 | | | | 21.2 | 10.0 | 6.0 | | | |
| 11 | 65.0 | | | | 20.0 | 15.0 | 6.0 | | | |
| 12 | 63.1 | | | | 19.4 | 17.5 | 6.0 | | | |
| 13 | 68.8 | | | | 21.2 | 10.0 | 6.0 | 10.0 | | |
| 14 | 65.0 | | | | 20.0 | 15.0 | 6.5 | 10.0 | | |
| 15 | 81.0 | | | | 4.0 | 15.0 | 6.5 | 10.0 | | |
| 16 | 65.0 | | | | 20.0 | 15.0 | 6.0 | | E-1 | 10.0 |
| 17 | 65.0 | | | | 20.0 | 15.0 | 6.0 | | E-2 | 10.0 |
| 18 | 65.0 | | | | 20.0 | 15.0 | 6.0 | | E-3 | 10.0 |
| 19 | 65.0 | | | | 20.0 | 15.0 | 6.0 | | E-4 | 10.0 |

| | St Component | | Retention | | | |
|---|---|---|---|---|---|---|
| | in Total | Stability | of | Resistance | Resistance | Resistance |
| Example | Acrylic | in Charging | Electrical | to Spent | to | to |
| No | Resins (%) | Capability | Resistance | Toner | Agglomeration | Abrasion |
| 1 | 4.3 | A | A | A | A | A |
| 2 | 7.3 | A | A | A | A | B |
| 3 | 14.3 | A | A | A | A | B |
| 4 | 21.3 | A | A | A | A | A |
| 5 | 21.3 | B | A | A | A | B |
| 6 | 21.3 | A | A | A | A | A |
| 7 | 30.3 | A | A | B | A | A |
| 8 | 21.2 | A | A | A | A | B |
| 9 | 21.3 | A | A | A | A | A |
| 10 | 21.3 | B | A | A | A | B |
| 11 | 21.3 | A | A | A | A | A |
| 12 | 21.2 | A | A | B | A | A |
| 13 | 21.3 | A | A | A | A | B |
| 14 | 21.3 | A | A | A | A | A |
| 15 | 4.3 | B | A | A | A | A |
| 16 | 21.3 | B | A | A | A | A |
| 17 | 21.3 | B | A | A | A | A |
| 18 | 21.3 | B | A | A | A | A |
| 19 | 21.3 | A | A | A | A | A |

TABLE 2

| Comp. | | | | | | | | Melamine | |
|---|---|---|---|---|---|---|---|---|---|
| Example | Acrylic Resin A | | Acrylic Resin B | | | Polystyrene | Fluororesin | Resin | Additive |
| No | A-1 | A-2 | B-1 | B-2 | B-3 | B′-1 | C-1 | B′-2 | D-1 |
| 1 | 42.5 | | | | 42.5 | | 15.0 | | 6.0 |
| 2 | 28.5 | | | | 56.5 | | 15.0 | | 6.0 |
| 3 | | | 85.0 | | | | 15.0 | | 6.0 |
| 4 | | | | 85.0 | | | 15.0 | | 6.0 |
| 5 | | | | | 85.0 | | 15.0 | | 6.0 |
| 6 | | | 65.0 | | 20.0 | | 15.0 | | 6.0 |
| 7 | | | | 65.0 | 20.0 | | 15.0 | | 6.0 |
| 8 | | | 85.0 | | | | 15.0 | | 6.0 |
| 9 | | | | 85.0 | | | 15.0 | | 6.0 |
| 10 | 85.0 | | | | | | 15.0 | | 6.0 |
| 11 | 65.0 | 20.0 | | | | | 15.0 | | 6.0 |
| 12 | 81.0 | | | | | | 15.0 | 4.0 | 6.0 |
| 13 | 76.5 | | | | | 8.5 | 15.0 | | 6.0 |
| 14 | 65.0 | | | | | 20.0 | 15.0 | | 6.0 |
| 15 | | 65.0 | | | | 20.0 | 10.0 | | 6.0 |
| 16 | 90.0 | | | | 10.0 | | | | 6.0 |
| 17 | 76.5 | | | | 23.5 | | | | 6.0 |

| | | Proportion | | Retention | | | |
|---|---|---|---|---|---|---|---|
| Comp. | | in Total | Stability | of | Resistance | Resistance | Resistance |
| Example | Additive | Acrylic | in Charging | Electrical | to Spent | to | to |
| No | D-2 | Resins | Capability | Resistance | Toner | Agglomeration | Abrasion |
| 1 | | 45.2 | C | A | C | A | C |
| 2 | | 60.0 | B | A | C | A | C |
| 3 | | 30.8 | A | B | B | A | B |
| 4 | | 60.9 | A | A | C | A | B |
| 5 | | 90.3 | C | A | C | A | C |
| 6 | | 44.8 | B | A | B | A | C |
| 7 | | 67.9 | B | A | C | A | B |
| 8 | 10.0 | 30.8 | C | B | A | A | C |
| 9 | 10.0 | 60.9 | B | A | B | A | B |
| 10 | | 0.0 | A | B | A | B | B |
| 11 | | 0.0 | C | A | A | A | B |
| 12 | | 0.0 | C | A | A | A | B |
| 13 | | 10.0 | C | A | A | A | B |
| 14 | | 23.5 | A | A | A | A | C |
| 15 | | 22.2 | C | B | A | A | C |
| 16 | 10.0 | 9.0 | C | B | B | B | A |
| 17 | | 21.2 | B | A | B | B | B |

As demonstrated in Table 1, the carriers the coating layer of which contains the styrene-free acrylic resin A, styrene-containing acrylic resin B, and fluororesin C and has a styrenic component in a proportion of less than 45.2 mass % in the total acrylic resins provide stable charging capability, show reduced resin abrasion and reduced variations in electrical resistance, and are effectively prevented from contamination due to spent toner and from agglomeration, even after the accelerated deterioration.

In contrast, as shown in Table 2, the carriers of Comparative Examples 1 and 2, in which the coating layer contains both the acrylic resins A and B with a proportion of the styrenic component of 45.2% or higher in the total acrylic resins, are inferior in resistance to spent toner and abrasion. In Comparative Examples 3 to 9, in which the acrylic resin A is not used, the carriers show large variations in charging capability or are inferior in resistance to spent toner, retention of electrical resistance, or resistance to abrasion, irrespective of the proportion of the styrenic component in the total acrylic resins. The carriers of Comparative Examples 10 to 12, in which the acrylic resin B is not used, have poor abrasion resistance and are inferior in retention of electrical resistance and resistance to agglomeration, or in stability in charging capability. In Comparative Examples 13 to 15, in which the proportion of the styrenic component is in the range as of the invention however in the sum of the acrylic resin B and the polystyrene resin, the carriers fail to exhibit abrasion resistance or have poor stability in charging capability. The carriers of Comparative Examples 16 and 17, in which the coating layer does not contain the fluororesin, are inferior in stable charging capability, resistance to agglomeration, and resistance to spent toner.

### INDUSTRIAL APPLICABILITY

The resin-coated carrier for electrophotography of the invention is satisfactory in terms of all of stable charging capability, stability in electrical resistance, and resistance to agglomeration, spent toner, and abrasion. The charrier of the invention can be used for low temperature fixing toners and has a long life.

1. A resin-coated carrier for electrophotography, comprising a magnetic core particle and a resin layer coating the core particle,
the coating layer comprising:
an acrylic resin A free of a styrenic component;
an acrylic resin B containing a styrenic component; and
a fluororesin; wherein
the styrenic component is present in a proportion of less than 45.2 mass % in the total of the acrylic resins in the coating layer.

2. The resin-coated carrier for electrophotography according to claim 1, wherein the acrylic resin B comprises 30 to 90 mol % of a repeating unit derived from a styrenic monomer relative to the total repeating units of the acrylic resin B.

3. The resin-coated carrier for electrophotography according to claim 1, wherein the coating layer has a content of the acrylic resin A of 55.0 to 81.0 parts by mass per 100 parts by mass of the total of the resins included in the coating layer.

4. The resin-coated carrier for electrophotography according to claim 1, wherein the coating layer has a content of the fluororesin of less than 20.0 parts by mass per 100 parts by mass of the total of the resins included in the coating layer.

5. The resin-coated carrier for electrophotography according to claim 1, wherein the fluororesin is polytetrafluoroethylene.

6. A two-component developer comprising the resin-coated carrier for electrophotography according to claim 1.

7. The resin-coated carrier for electrophotography according to claim 2, wherein the coating layer has a content of the acrylic resin A of 55.0 to 81.0 parts by mass per 100 parts by mass of the total of the resins included in the coating layer.

8. The resin-coated carrier for electrophotography according to claim 2, wherein the coating layer has a content of the fluororesin of less than 20.0 parts by mass per 100 parts by mass of the total of the resins included in the coating layer.

9. The resin-coated carrier for electrophotography according to claim 2, wherein the fluororesin is polytetrafluoroethylene.

10. A two-component developer comprising the resin-coated carrier for electrophotography according to claim 2.
